(19) United States
(12) Patent Application Publication
(10) Pub. No.: US 2005/0226449 A1
(43) Pub. Date: Oct. 13, 2005

(54) Massage speaker unit

(76) Inventor: Scott Young, Ventura, CA (US)

Correspondence Address: WOODROW DOUGLAS ENGLISH, III;COUNTY SQUARE PROFFESSIONAL OFFICES, 674 COUNTY SQUARE DRIVE, SUITE 101, VENTURA, CA, 93003, US

(21) Appl. No.: 11/064,034

(22) Filed: Feb. 22, 2005

Related U.S. Application Data
(60) Provisional application No. 60/547,023, filed on Feb. 23, 2004.

(51) Int. Cl. H04R 5/02; H04R 1/02; H04R 9/06

(52) U.S. Cl. 381/333; 381/301; 381/388

(57) ABSTRACT

A portable sound and vibration transmission device, compatible with common audio producing means, designed to enhance the relaxation experienced by a massage therapy client through the use of an upward facing subwoofer and distal cylinders containing speaker drivers positioned to create a surround sound effect.

### PRIOR APPLICATION

This application emanates from a prior Provisional Patent Application filed Feb. 23, 2004, Ser. No. 60/547,023.

### FIELD OF THE INVENTION

This invention relates to the field of therapeutic massage and any therapy which benefits from the relaxation of an individual lying on a table or bed with music involving the use of a portable means for supplying a massage client with sound vibrations through the table surface and adjacent walls of the treatment room where the client is placed for treatment.

### BACKGROUND OF THE INVENTION

It has long been well understood that music and sound vibrations can have a very therapeutic effect on the human body. This is a particularly important effect in the area of therapeutic massage or treatment involving a desire for relaxation or musical enjoyment. For example, massage therapists routinely employ the use of music in a room in which a client is lying prone on a surface and receiving a massage. Typically, however, this music is delivered in such a manner that the sound vibrations are not fully exploited for their therapeutic effect. Specifically, the music is playing in the room, but the sound is not dispersed evenly throughout the room and the vibrations do not come in direct contact with the body of the massage client.

When music is played from a single directional source (as from a “boombox,” or single ceiling-mounted speaker) the person on the massage table experiences it as “a stimulation from somewhere over there.” Furthermore, portable “boombox” style music systems used by many massage therapists and spas are a very poor source for deep bass. At the low volumes used for massage, the bass cannot be felt or heard as was intended by the musician. In many instances, the amount of relaxation the music itself produces seems to be directly proportional to the amount of deep and resonating tones effectively reproduced by the sound system.

The vibrating sound therapy tables currently on the market are the only means for transmitting accurate bass at low volumes to the client. These tables, however, are not portable and have to be powered by separate amplifiers. Additionally, they require separate speakers or headphones to reproduce a full range of sounds. Current state of the art is too complicated and time consuming for the repeated setup of a portable sound system.

Many spas do not want speakers mounted on walls for aesthetic reasons. It is also expensive to mount and wire wall speakers. Furthermore, many speakers would be required in order to reproduce a surround sound effect. Even if a typical surround system were an option, the subwoofers used to emanate bass conventionally have the disadvantage of tending to bleed bass frequencies into adjacent rooms.

The prior art in the field includes many devices that involve the use of transmitting music to a listener for the general purpose of relaxation. Schwartz et al in U.S. Patent Application Publication US20010052153A1 involves a seated cushion that massages the person sitting in the seat and providing a means for music to reach the head and ears of the person using the cushion. Similarly U.S. Patent Application Publication US20030139693A1 by Swift involves a dental chair that provides music to the patient through headphones connected to the chair. Kerr in U.S. Pat. No. 3,156,500 also involves a dental chair component that emits sounds to the patient during dental treatment. These inventions, however, do not address the need for sound vibrations to be delivered to the prone body of a massage patient.

Additionally, many more inventions exist that transmit sound to the head of a person seeking relaxation. U.S. Pat. No. 3,621,155 by Pruit involves a stereo pillow; U.S. Pat. No. 4,038,499 by Yeaple teaches of a stereophonic pillow speaker system; Wiseman teaches of a stereophonic head rest in an automobile in U.S. Pat. No. 4,042,791; Yamada in U.S. Pat. No. 4,064,376 discloses an invention that causes music vibrations to enter the human body and reproduce the effects of live music in a chair or a bed; Nordskog teaches of a headrest with speakers for use on airplanes in U.S. Pat. No. 4,440,443; Hufnagle in U.S. Pat. No. 4,797,934 teaches of a speaker headrest; Nixdorf in U.S. Pat. No. 4,991,222 involves sound reproduction directed to the listener's head; both Albert in U.S. Pat. No. 5,123,133 and Redewill in U.S. Pat. No. 5,313,678 disclose inventions that provide an orthopedic pillow with speakers and an acoustical pillow, respectively; Eaken in U.S. Pat. No. 5,368,359 discloses a device that is an acoustical chair with a sound enhancing hood; and Lamm in U.S. Pat. No. 6,023,801 teaches of a therapeutic headrest.

Prior art more closely related to the problems transmitting sound to a massage patient can be found in U.S. Pat. No. 2,821,191 by Paii that teaches of an invention that provides pulsation to the human body. This device is not portable, and it transmits only pulses, not music. Most pertinent to the instant problem are inventions disclosed by Abbeloos in U.S. Pat. No. 4,124,249, by Vogel in U.S. Pat. No. 4,753,225, by Chesky in U.S. Pat. No. 5,035,235, by Eaken in U.S. Pats. No. 5,097,821 and 5,2165,769, and by Moriyasu in U.S. Pat. No. 6,027,463. Each of these inventions involves similar ideas to the instant invention. However, each one also holds limitations that are addressed by the current invention.

Briefly, the Abbeloos device involves thoracic stimulation through a sound transmitting system. However, the sound produced by this device is not ideal for use in massage. The sounds are broadcast toward the head of the client and not throughout the room. This dynamic eliminates the possibility of the sound reflecting away from the ears of the massage patient. Optimally, sound needs to reflect away from the ears of the massage patient for proper sound reflection and enjoyment. With the sound reflected throughout the room, the massage therapist can be synchronized with the sound and vibrations supplied by an audio source. Additionally, supplying sound that can be fully experienced by the therapist would require the use of a separate sound system.

The Vögel invention involves therapy equipment for the human body through the use of sounds and oscillators. However, this invention is very complex and not portable. Chesky teaches of a music vibration table and system that collects data and purports to distribute sound to the body to control pain. This invention is likewise highly complex and not portable.

Eakin teaches two separate relevant inventions. In U.S. Pat. No. 5,097,821 a somatic musical exposure system is disclosed. Like the Vögel invention, this invention is highly complex and not portable. In the Eaken invention disclosed by U.S. Pat. No. 5,216,769 a foldable bed is disclosed containing sound-generating capabilities. Again, this invention supplies music and sound vibration to the human body, but it remains complex and bulky. Finally, Moriyasu discloses a music massager that provides music delivery from an audio source located away from the table whereon the client is lying. Again, this invention is highly complex and not portable.

Thus, a need exists to address the limitations of the current state of the art in the field. Specifically, a need exists for a product that is simple and portable that provides therapeutic sound massage to a human body in a manner conducive to relaxation.

### SUMMARY OF THE INVENTION

In the preferred embodiment of the invention, a massage speaker unit is supplied for attachment to the underside of a massage table or surface to provide for the massage recipient a relaxed and simultaneously invigorating experience. The sound penetrates through the surface as vibration, and reflects off of adjacent walls and objects around the massage recipient producing a non-directional surround-sound effect. The unit may or may not be portable, depending on the requirements of the user. To achieve portability, the speaker uses magnets installed into the planar/table surface and steel washers installed above the cylinders to attach the speaker unit to the underside of the massage table, while the stationary model uses bolts or brackets for a semi-permanent installation. In instances where the underside of the surface has equipment already installed in the center (as when hydraulics are used to raise or lower the massage table), two units may be used toward either side of the table, thereby balancing the sound and vibration on both sides. The unit is pre-amplified with speakers enclosed in the top of the unit and in the distal cylinder handles which disperse the sound and allow for easy transportation of the device using the cylinders as handles. Sound is transmitted through the holes or the speaker grill in the cylinders to achieve maximum dispersion by aiming at least two drivers in each cylinder toward each corner of the planar surface of the massage table. The direction of each driver is important to achieve a 360 degree sound emission. While the client lies on top of the table with the unit underneath him or her, this configuration makes for perfectly balanced and reflected sound.

When people speak, sound is naturally reflected back to them in this manner. When music is transmitted this way, it sounds like it is coming from inside of the person, especially when the vibrations from the lower frequencies are literally felt inside the body. It sounds and feels similar to what a musician playing a musical instrument might feel, which gives a depth revealing more of the musician's divine inspiration while creating music. This effect is not reproduced by most sound systems—especially at low volumes. This effect adds a new dimension to the music and the massage client's experience, and will give the therapist a new tool for relaxation.

Any portable music producing device, such as a walkman, cd player or boombox that has a one-eighth inch mini-headphone jack can be used to supply music to the device. The source of the audio can also come from a standard RCA jack found in common home audio equipment by using a common RCA to mini RCA type adapter.

MP3 players are relatively new technology for distributing music and are not usually employed by most massage therapists. However, they are extremely useful because of their ability to put a lot of different music into a small form factor, and their ability to make playlists for different treatments and clients. As familiarity and acceptance of the use of MP3 players grow amongst massage therapists, these advantages can enhance the use of the device. The instant invention makes it possible to utilize the unique advantages of an MP3 player in this way. The device works with portable CD players and tape decks, which are all usually already owned by most people. Ideally, it would work best if an MP3 player could be built into the unit, with the music preloaded and organized.

### OBJECTS OF THE INVENTION

The principal object of the invention is to provide a uniquely relaxing sound experience that envelopes the listener in balanced surround sound and relaxing tactile bass.

Another object of the invention is to provide a portable tool that is attractive and professional and easy to set up.

### BRIEF DESCRIPTION OF THE DRAWINGS

FIG. 1 illustrates a perspective view of the portability of the two unit sound system and massage table.

FIG. 2 illustrates a perspective view of the portable sound massage system assembled for use.

FIG. 3 illustrates an exploded view of the device.

FIG. 4 illustrates the device in use with a human body lying on a surface prior to the device being attached to the surface.

FIG. 5 illustrates the device in use with a human body lying on a surface after the device has been attached and activated, and further indicates typical sound emanations.

### DETAILED DESCRIPTION OF AN ENABLING AND PREFERRED EMBODIMENT

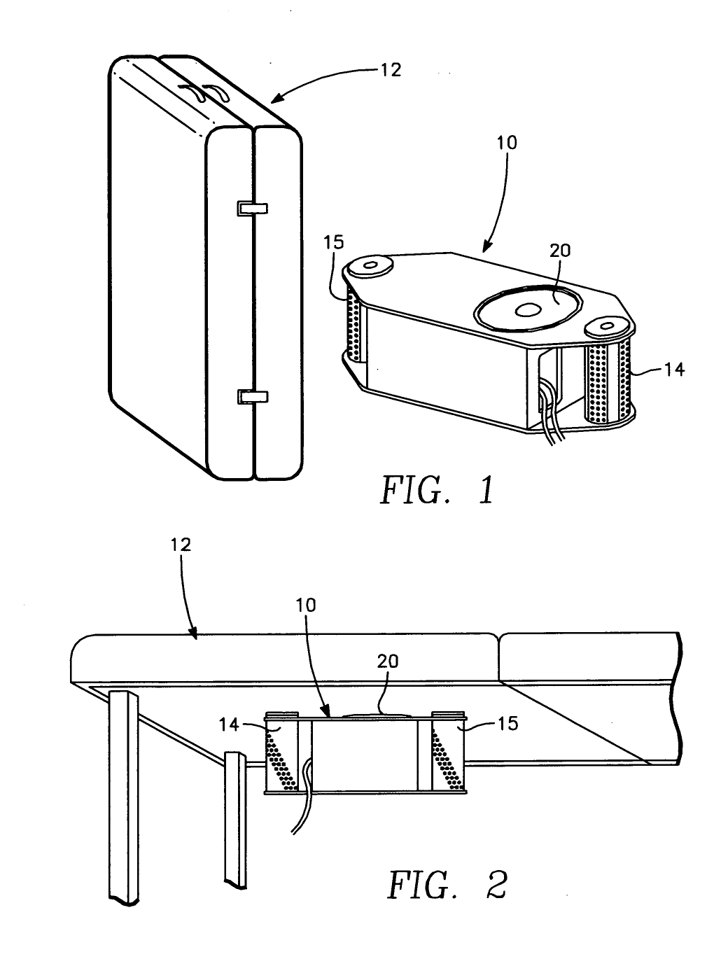

For a better understanding of the invention, turning now to the drawings, FIG. 1 illustrates a perspective view of the invention 10 adjacent a portable, fold up massage table 12. FIG. 1 clearly illustrates the portable nature of the invention concept. The cylindrical driver units 14 clearly serve as a convenient carrying and mounting handle for the invention sound system 10.

FIG. 2 illustrates a perspective view of the invention system assembled for use in a typical portable massage environment.

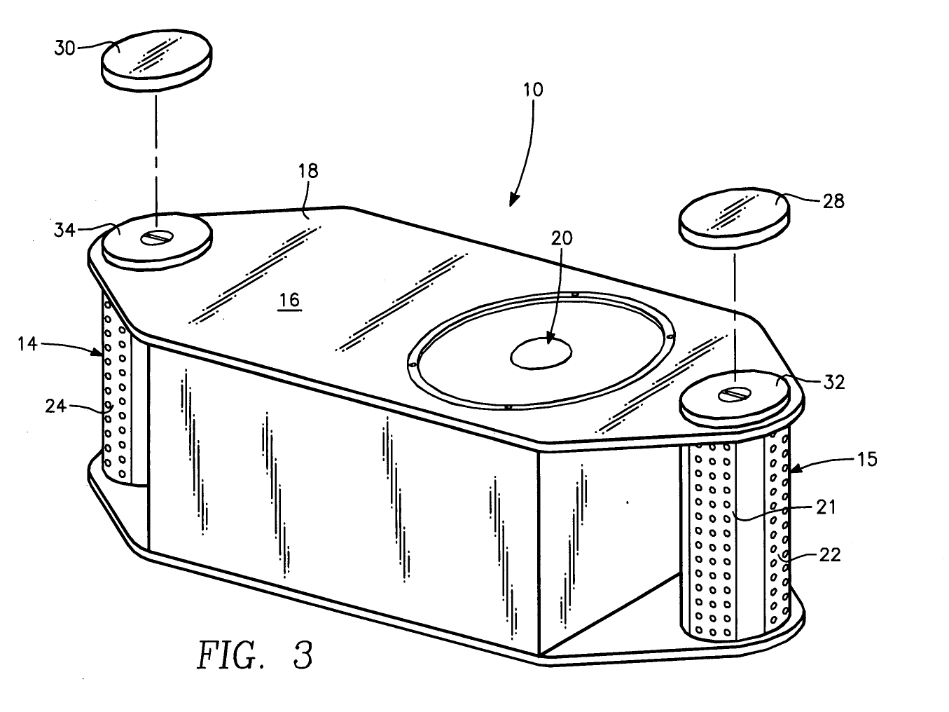

FIG. 3 illustrates a perspective, exploded view of the invention 10. The invention sound transmitting device 10 consists of a somewhat rectangular enclosure or housing 16 that encloses therein the various speaker drivers as well as the various sound producing systems. Housing 16 incorporates in a top side 18 thereof a woofer driver 20 that is to be mounted in close proximity to the underside of the massage table12. On either end of housing 16 we find a pair of cylindrical full range driver housings 14 and 15. Driver housings 14 and 15 customarily have a speaker mesh or grill 20 and 22 as well as 24 and 26 at right angles to each other to effectively direct and deliver the sound emanating from sound device 10 in four discrete directions to effectuate a “surround sound effect” to one lying on the massage table 12.

The attaching mechanism for the sound transmitting device 10 in the preferred embodiment consists of a first and second magnets 28 and 30 that are positioned on the bottom side of the massage table 12 in a manner to coincide exactly with ferro magnetic plates 32 and 34, respectively. By such means the sound transmitting device 10 will be securely mounted to the massage table for use and may equally be disassembled, separated for packing and storing the devices when not in use.

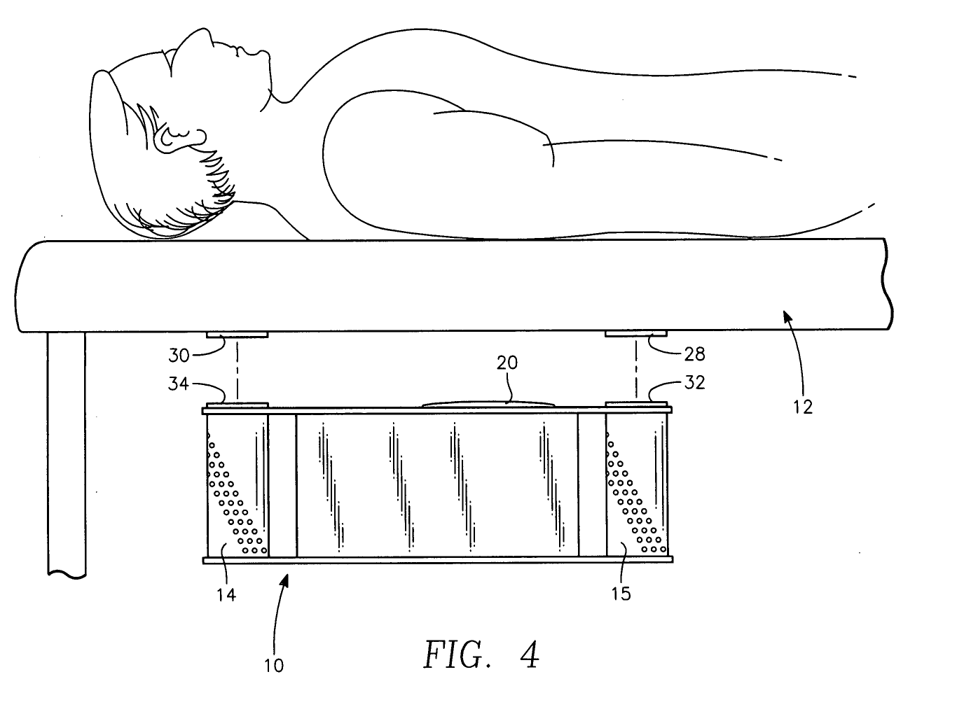

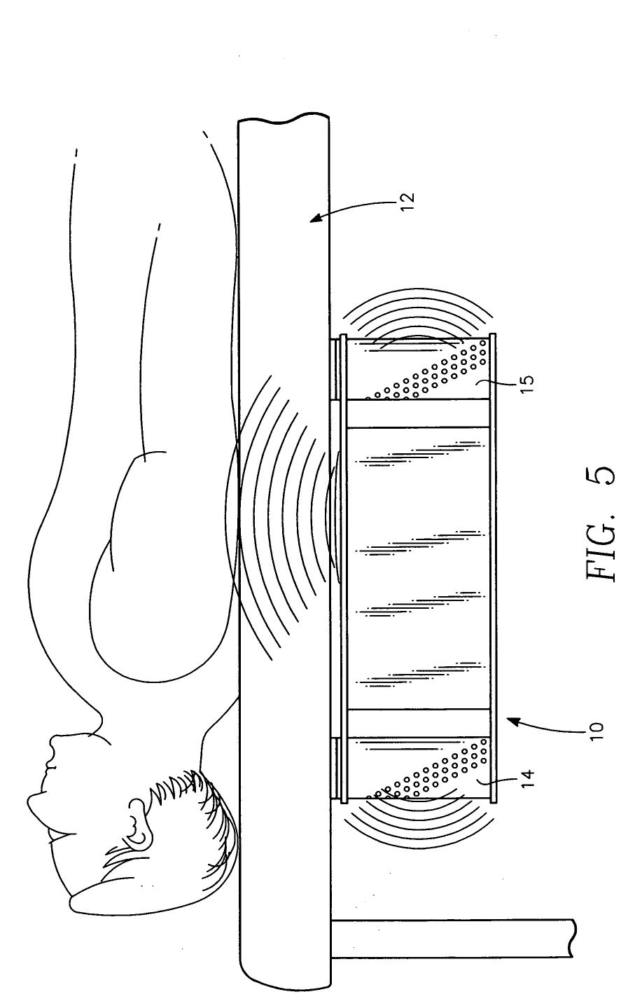

Referring now to FIGS. 4 and 5, it can be easily observed how effectively and easily that the sound transmission device 10 can be mounted under massage table 12 where metal plates 32 and 34 are lined up with magnets 28 and 30 respectively for mounting the sound device 10. Woofer speaker driver 20 is thereby situated adjacent the underside of table 12 and as illustrated in FIG. 5 sound vibrations emanate evenly and flow throughout the thoracic area of an individual lying on the massage table 12. Correspondingly, and in addition to the foregoing delivered sound and vibrations, we also have sound emanating from the cylindrical housings 14 and 15, which sound spreads evenly throughout the room to effect a “full room, surround sound” atmosphere while concomitantly feeling the sublime and internal vibrations of sound throughout the body whilst in the midst of relaxing massage. The illustrations and examples provided herein are for explanatory purposes and are not intended to limit the scope of the appended claims, as those skilled in the art will make modifications to the invention for particular massage tables and environments. Although the invention was initially intended for massage, its innovations can be used and developed creatively for other applications.

1. A sound transmitting device attached to a planar surface for therapeutically transmitting relaxing sounds and associated vibrations through said surface and also through out the room in which said planar surface is situated in a manner to yield a surround sound effect to an individual lying upon said surface, comprising:
A portable sound producing housing enclosure attached to the underside of said planar surface for containment of a sound producing system including a plurality of different drivers;
At least one subwoofer driver disposed on a surface of said enclosure and facing the underside of said planar surface;
At least two cylindrical speaker enclosures disposed on distal ends of said housing enclosure, each said cylinder having at least one full range driver in each cylinder mounted in somewhat opposing direction to the other full range driver,
Means for attaching said sound producing housing to said planar surface.

2. A sound transmitting device according to claim 1, wherein said sound producing system is portable music device.

3. A sound producing system according to claim 2, wherein said portable music device is a compact disc player.

4. A sound producing system according to claim 2, wherein said portable music device is a boom box.

5. A sound producing system according to claim 2, wherein said portable music device is an MP3 player.

6. A sound producing system according to claim 2, wherein said portable music device is a Personal Computer.

7. A sound transmitting device according to claim 1, wherein said cylinder housings contain at least two full range drivers mounted orthogonal to said woofer driver and each of the four said full range drivers pointed to a different corner of the planar surface.

8. A sound transmitting system according to claim 1, wherein said means for attaching said audio housing consist magnetic attachment means.

9. A sound transmitting system according to claim 8, wherein said magnetic attachment means automatically places the woofer driver in a position juxtaposed to the thoracic region of and individual lying on the planar surface.

10. A method for therapeutically transmitting relaxing sounds and associated vibrations to an individual lying upon a planar surface, comprising the steps of:
Attaching a sound producing device with drivers to the undersurface of said planar surface;
Placing at least one woofer driver of said device in close proximity with the underside of said planar surface;
Placing at least a pair of general speaker drivers of said device disposed orthogonal to said woofer driver.

11. A portable therapeutic device for applying and transmitting sound waves though a portable massage table to an individual lying thereon, comprising:
A somewhat rectangular audio housing for containment of a sound producing system and a plurality of speaker drivers;
A single woofer driver of said housing disposed on the underside of said massage table directed toward and in close proximity to the under surface of said massage table;
A first and second cylindrical general purpose driver housing of said audio housing disposed orthogonal to said woofer driver and oriented to emit sound in opposing directions to each other, wherein said cylindrical housings also serve as handles for portable mounting and transporting;
Non permanent means for attaching said audio housing to the underside of said portable massage table.
